(19) United States
(12) Patent Application Publication
(10) Pub. No.: US 2025/0019150 A1
(43) Pub. Date: Jan. 16, 2025

(54) COMPOSTABLE GASKET FOR A COMPOSTABLE BEVERAGE POD

(71) Applicant: Nexe Innovations Inc., Surrey (CA)

(72) Inventors: Darren Joseph Footz, Surrey (CA); Kianoush Karmini Pour Kerman, Vancouver (CA)

(21) Appl. No.: 18/582,594

(22) Filed: Feb. 20, 2024

Related U.S. Application Data
(63) Continuation of application No. 17/748,995, filed on May 19, 2022, now abandoned.
(60) Provisional application No. 63/190,580, filed on May 19, 2021.

(51) Int. Cl. B65D 85/804; B65D 65/46

(52) U.S. Cl. CPC B65D 85/8064; B65D 65/466

(57) ABSTRACT

A Gasket for a beverage pod, comprising: A beverage pod comprising an exterior portion and an interior portion, A gasket disposed about the exterior portion of the beverage pod, wherein the gasket provides a seal between a brewing device and the exterior portion of the beverage pod, the seal thereby providing a means to maintain a pressure differential between the interior portion of the beverage pod and the exterior portion of the beverage pod.

### CROSS-REFERENCE TO RELATED APPLICATIONS

The present application claims the priority benefit of U.S. provisional patent application 63/190,580 filed May 19, 2021, the disclosure of which is incorporated herein by reference.

### FIELD OF THE DISCLOSURE

The present disclosure relates to a beverage cartridge such as, for example, a compostable beverage cartridge for single-serve use. The present disclosure further relates to methods of manufacture and uses thereof. The present disclosure further relates to beverage pods, such as a single-serve coffee pods. The present disclosure more specifically relates to high-pressure beverage pods, such as those used to brew espresso beverages.

### BACKGROUND

Single-serve beverage cartridges have become a dominant method for serving beverages, especially hot beverages, in a variety of settings such as homes, offices, waiting rooms, hotel rooms and lobbies, and other places where people consume beverages. The rapid growth of single-serve beverage cartridges is driven by consumer preference for convenient, quickly prepared beverages in single-portion quantities, in a variety of flavors, beverage types (coffee, espresso, decaffeinated coffee, tea, decaffeinated tea, cider, hot cocoa/chocolate, bone broth, and even alcoholic beverages, such as, for example, Irish Coffee, Hot Toddy, Hot Buttered Rum, etc.). Even within a beverage type, such as coffee, there may be a plurality of roasts and associated roasters, flavor profiles, flavor additives, caffeine strengths, location, or locations of origin, etc.

The convenience and variety of single serving beverage cartridges allows and encourages consumers to prepare and consume a plurality of beverages throughout the day. This pattern of consumption causes the rapid accumulation of used beverage cartridges wherever they are consumed. Due to the nature of single-serving beverage cartridges, a considerable amount of packaging waste is produced per beverage consumed compared to preparing beverages by traditional means, such as, for example, preparing a plurality of servings at once using bulk ingredients. Packaging waste, according to the United States Environmental Protection Agency (EPA), defines containers and packaging as products that are assumed to be discarded the same year the products they contain are purchased. The EPA further estimates that the majority of the solid waste are packaging products. Packaging waste contributes significantly to global pollution, the introduction of contaminants into the natural environment that cause adverse change, which poses a health risk many forms of life, including humans, other animals, plants, fungi, etc.

Single-serve beverage cartridges typically comprise several components made of various materials. The typical components of a single-serve beverage cartridge include, at least, a container, typically made from plastic such as polyethylene, a filter, typically made from plant fiber such as abaca fibers or other natural and synthetic fibers, and a container lid, typically made from food-grade aluminum foil, which is also commonly printed upon to include product labelling. Some beverage cartridges do not contain a filter, typically because the beverage material is readily soluble in hot water (such as, for example, hot cocoa). The container will usually comprise an opening on the top of the container, and a hollow cavity within which and across which a filter may be disposed. The container may also comprise an opening at on the bottom container. After the filter and beverage material are inserted into the container, the lid is then typically sealed over the container opening or openings. The sealed lid typically provides an airtight seal, preventing the exchange of gases between the environment and the interior of the container, thus preventing oxidation and/or spoilage of the beverage material. In beverage cartridges that comprise a filter, the filter may separate the container into two chambers: a first chamber occupying the space within the container between the filter and the opening of the container, the first chamber for holding dry beverage ingredients such as, but not limited to, coffee, tea, or cocoa, for a single beverage serving; and (ii) a second chamber occupying the space within the container between the filter and the base of the container, the second chamber being on the opposite side of the filter to the first chamber. The purpose of the second chamber is typically to provide a space in which a fluid extractor of a beverage brewing device may be inserted into the bottom of the container, entering the second chamber, and allowing the extraction of fluid from the cartridge without the fluid extractor entering the first chamber, such that fluid flows through the beverage material and the filter before exiting the cartridge via the fluid extractor. However, the presence of the second chamber may significantly reduce the space within the container that can be occupied by beverage medium. This may be problematic as the total amount of beverage material disposed within the container may significantly contribute to the final concentration of the beverage, typically measured in Total Dissolved Solids (TDS). It may be advantageous to minimize the volume of the second chamber in order to maximize the volume on the third chamber, thereby maximizing the total volume available for beverage material. However, the fluid extractor is typically comprised of a sharp, hollow needle-like piercing element designed to easily pierce through the bottom of the container, such that if the second chamber is reduced in size, the fluid extractor may penetrate or damage the filter, allowing the beverage material to exit the first chamber, and ultimately exit the cartridge via the fluid extractor. Thus, in the event the fluid extractor penetrates or damages the filter, the beverage material may be transported into the final beverage, which may be undesirable to consumers (such as, for example, the presences of coffee grounds in a prepared cup of coffee) and may potentially damage the beverage brewing machine (for example, by way of clogging the fluid extractor with beverage material).

The cover is disposed over the opening of the container (which may be, for example, over the top of the container, and/or bottom of the container), and keeps the dry beverage ingredients within the container, as well as providing an airtight seal to prevent the oxidation and other types of degradation of the container's contents. In practice, a single-serving beverage cartridge is placed into a compartment of a brewing machine. The machine is activated such that a fluid injector penetrates the cover of the cartridge and a fluid extractor penetrates the base of the cartridge (which may also be a cover). The fluid injector injects a brewing medium (e.g., hot water) into the first chamber for extracting beverage components from the ingredients. The brewing medium containing the extracted beverage components percolates through the filter and into the second chamber. The brewing medium containing the extracted flavors is then extracted by the fluid extractor and finally dispensed as a drinkable beverage.

Currently, the container of a beverage cartridge for single-serve use is typically made from petroleum-based plastic materials which are neither biodegradable nor compostable. In some cases, the container may be made of petroleum biodegradable materials, such as Polybutylene adipate terephthalate (PBAT). Biodegradation is the decay of organic substances, such as dead plant matter, which are allowed to decompose to the point that various waste products provide nutrients to soil. Biodegradation can be aerobic and/or anerobic depending on the environment. Aerobic is the decomposition of organic matter by microbes that require oxygen to process the organic matter. The oxygen from the air diffuses into the moisture that permeates the organic matter, allowing it to be taken up by the microbes. Anerobic biodegradation is the decomposition of organic matter by microbes that do not require oxygen to process the organic matter. To be anerobic, the system should be sealed from the air, such as with a plastic barrier. Anerobic compositing produces an acidic environment to digest the organic material. A portion of the organic matter may additionally be converted to vermicast, or castings from worms or other animals.

The cover of a beverage pod is typically made of a metal foil (e.g., aluminum) or a metal foil laminate which is glued to the top of the container. Generally, neither the metal foil of the cover nor the glue affixing the cover over the opening of the container is biodegradable, compostable, or made from readily renewable resources. As a result, non-biodegradable and non-compostable beverage cartridges typically end up in landfills, thereby at least contributing to environmental concerns associated with disposal of trash. This may be especially problematic due to the fact that traditional means of brewing beverages, e.g., using solely beverage material and filter material, or a filtration device (such as a French press, or a wire mesh filter) may yield a completely compostable waste product (e.g., spent coffee grounds and potentially a used paper filter).

Attempts have been made to recycle plastic beverage pods in some cases. Recycling has many issues which effect the efficacy and practicality of these programs. The first is collection and transportation. Collection largely requires voluntary compliance by consumers. Some deposit programs encourage consumers to return recyclable materials, however this accounts for very few recyclable materials. Collection is further complicated by the need to further transport the materials to a facility which can process them. Many of these facilities are run by municipalities as recycling operations frequently lack economic viability without government subsidies. Recycling of plastics and other materials is further complicated by cross contamination and downcycling. Cross contamination is the presence of foreign materials not desired in the end product and can include materials such as other non-recyclable waste, or other recyclable wastes not compatible with the desired recycled material which can include other plastics. This requires sorting and cleaning of materials. This process can be partially automated; however, it also requires manual sorting and inspection which adds cost, reduces the amount of material that can be processed and inevitably results in a less pure product than when using virgin material. This frequently results in downcycling.

Downcycling is the term used to describe the reduction of quality in recycled materials compared to materials prior to being recycled. Impurities introduced during processing, from non-recyclable waste that could not be removed, or from other plastics and materials can make the resulting material unsuitable for use in their original applications. As such, the applications for recycled materials, especially plastics, are limited, as is the number of times that plastics can be recycled.

Beverage containers, such as instant beverage cups or pods, are particularly difficult to recycle. Not only do they have non-recyclable material contained within them that would first need to be removed, but they are also frequently comprised of at least two different materials, such as a plastic cup and an aluminum foil lid. When the lid is made of plastic, it is often a different type than the cup, and would require separation prior to processing when being recycled. This increases the complexity of the recycling operation, requiring at least three separate streams for each type of refuse, each requiring their own preparation. Furthermore, the small size of these beverage pods creates a disproportionate amount of effort required to recycle a small amount of material. The separation of materials would ideally be performed by the consumer prior to recycling; however, this inconvenience will inevitably result in consumers recycling the beverage containers without proper preparations, or failing to recycle the container at all, electing to discard the container as trash. One of the major advantages of using beverage pods is consumer convenience, such that a beverage can be prepare by simply inserting a cartridge into a machine that performs all other brewing functions. It is therefore undesirable to instruct consumers to disassemble and sort various materials from the beverage pod, and due to the diminutive size of beverage pods, this may not be physically possible for consumers without fine motor skills necessary to disassemble such an item. The result is a required step of preprocessing the containers before they can be recycled to ensure the materials are separated and the recyclable material sufficiently cleaned.

Plastics are traditionally sourced from petroleum. They are processed with chemicals to create polymers which can then be formed into shapes. Such polymers that are heated to be formed and then hold their shape when cooled are called thermoplastics. Many of the chemicals used to produce these polymers are inherently toxic and can leech into the contents. This is why few types of plastics are approved for use with foods. Some materials may be safe storing some types of food products, such as dry goods, however when a solvent is introduced, the chemicals in the plastic can go into solution. In the past, some plastics that were previously approved for use with foods have been found to leech chemicals, such as BPA (Bisphenol A). Depending on the chemical and the manner in which the plastic is being used, it can cause problems including irritation in the eye, vision failure, breathing difficulties, respiratory problems, liver dysfunction, cancers, skin diseases, lung problems, headache, dizziness, birth defects, as well as reproductive, cardiovascular, genotoxic, and gastrointestinal issues.

There has been a push from some governments to mandate composting and increase the amount of recycled material to reduce the amount of waste being incinerated or buried in landfills. Some laws such in the European Union, set specific targets, such as 65% of waste recycled by 2035. In the United States, there is no national law, but roughly half of states have some form of recycling law and municipalities may further add to these laws resulting in a varying patchwork of regulations and mandates. Some laws are very limited, requiring that some bottles and cans be recycled. Many of these states also add deposits to bottles, adding monetary value and incentive to returning them for recycling. Others require only specific recyclable materials be recycled, while others may be permitted to be discarded in the trash. Some states go further, mandating that compostable waste be disposed of properly, either in a home composter, or via an industrialized composting operation.

A further complication to composting plastics is that not all plastics break down the same. Some plastics, whether petroleum based or those which originate from biomass, are biodegradable. Only a small subset of these materials are also compostable. The distinction lies in how quickly the plastic breaks down, and whether the process of degradation releases harmful chemicals into the environment. Compostable plastics typically degrade within 12 weeks, wherein biodegradable plastics will typically break down within 6 months. Ideally, compostable plastics would break down at the same rate as common food scraps, about 90 days.

Another class of plastics are OXO-degradable plastics. These are different than biodegradable plastics in that they are traditional plastics with additional chemicals which accelerate the oxidation and fragmentation of the materials under UV light and/or heat. This allows the plastics to break down more quickly, however the result is pollution from microplastics, as the plastic molecules themselves do not degrade any faster than their traditional plastic counterparts. There have been efforts in some jurisdictions to ban these plastics.

In order to brew certain types of brewed beverages, like espresso, for example, it is necessary to expose the beverage material to brewing liquid under pressure. This presents a challenge for beverage pod manufacturers. Beverage pods are typically made of rigid thermoplastic, such PHA in the case of compostable beverage pods. Due to the rigidity of the material, creating a tight seal with the beverage brewing device to maintain the high pressure of water needed for certain extractions, like espresso, may be especially difficult.

Gaskets are one method of creating a tight seal between two rigid objects. However, traditional gaskets may not be suitable for a compostable beverage pod. Many gaskets are comprised of materials such as rubber, silicone, metal, cork, felt, neoprene, nitrile rubber, fiberglass, polytetrafluoroethylene (otherwise known as PTFE or Teflon) or a plastic polymer (such as polychlorotrifluoroethylene), which are not suitable for compostable packaging. Other traditional gasket materials, like paper, may not create a tight enough seal to withstand the pressure of a brewing machine designed for high pressure extraction beverages.

There exists a need to provide a compostable coffee pod capable of creating a tight pressure seal to aid in the creation of single serve beverages, such as espresso and the like.

### BRIEF DESCRIPTIONS OF THE DRAWINGS

FIG. 1: Illustrates a Compostable Beverage Pod, according to an embodiment.

FIG. 2: Illustrates a Compostable Gasket, according to an embodiment.

FIG. 3: Illustrates a Pod with Gasket, according to an embodiment.

FIG. 4: Illustrates a Embodiment, according to an embodiment.

FIG. 5: Illustrates a Method, according to an embodiment.

### DETAILED DESCRIPTION

FIG. 1 is a system for a Compostable Beverage Pod. This system comprises of Beverage pods, or beverage cartridges, are containers, pods, capsules, etc., for use in a beverage brewing machine, such as a coffee maker. They may include one or more of, a beverage medium that is either soluble or insoluble, one or more filters and a first portion in which liquid is passed into and a second portion through which liquid passes out of the cartridge. In some instances, they are portioned beverage packages often contain a water-soluble material, to make a drink such a hot chocolate, chai tea, etc. These portioned packages can be pouches as well as pods for beverage brewing machines, element 102. Beverage cartridges can contain a number of components, including pod lid, capsule lid, or cartridge lid, is one component of a beverage pod, often made of foil, that is sealed to the pod, cartridge, capsule, etc., so as to contain the beverage medium. A compostable capsule lid may be comprised of, for example a spun bond PLA web film (which may contain a proportion of PHA, in some embodiments), a cellulose paper film, etc., element 104. The pod bond is the connection between any two of the capsule lid, capsule outer shell, and capsule interior. This bond can be mechanical or chemical, and such as adhesives, heat sealing, ultrasonic welding, etc. The pod bond and the filter bond can be in one place or separately depending upon the use case. A filter bond is a type of capsule bond that binds the filter medium to a portion of the capsule, such as by ultrasonic welding, adhesives, thermal sealing, etc., element 106. A pod exterior, or capsule, or cartridge is the outer shell of the beverage cartridge. The exterior can be made of plastic (especially compostable plastic, such as PLA, PHA, or combinations thereof), cellulose, etc. It has similar properties to other thermoplastic polymers such as polypropylene (PP), polyethylene (PE), or polystyrene (PS). This allows it to serve as a biodegradable alternative for coffee pods. It can also be made from polyhydroxyalkanoates (PHAs), which are a biodegradable polyester produced through bacterial fermentation of sugar or lipids. They can be used as alternatives to other synthetic plastics. The mechanical properties of PHAs can be modified for a given use case by blending it with other biodegradable polymers, such as PLAs. They can also be made from poly(L-lactide) (PLLA), which is a polymer that is also biodegradable and compostable. The material may be used to form various aspects of the beverage cartridge. PLLA is also readily renewable, typically made from fermented plant starch such as from corn, cassava, sugarcane, or sugar beet pulp. Cellulose fibers are fibrous materials made from plant materials such cotton, flax, wood pulp, etc. They provide a biodegradable filter material that could be used in coffee pods. Other materials that are biodegradable plastic alternatives include petroleum based plastics such as, Polyglycolic acid (PGA), Polybutylene succinate (PBS), Polycaprolactone (PCL), Polyvinyl alcohol (PVOH) and Polybutylene adipate terephthalate (PBAT), element 108. In some embodiments, the compostable pod may comprise at least one compostable gasket, element 110. The compostable gasket may be, for example, a flat ring, similar in share to a mechanical washer, of cellulose fiber with a layer of PLA on one side of the flat ring. The side of the compostable gasket with a layer of PLA may be placed against the underside of the upper lip of the beverage pod, as shown in FIG. 1. The PLA side of the compostable gasket may then be fused to the capsule 108, using any such methods as described by the pod bond 106. In an exemplary embodiment, the compostable gasket 110 is fused to the capsule 108 using ultrasonic welding. A filter guard, or faceplate, is a solid structure integrated into a beverage pod that prevents the outlet piercing element from creating a path for the insoluble beverage material from inside the filter to the outlet. In some embodiments, the capsule interior may include integrated features to act as a filter guard, removing the requirement for a discrete component, element 112. A filter is a medium, such as spun bond PLA web, paper (cellulose), cloth or metal, that is used to prevent an insoluble beverage material from leaving the beverage pod and entering the beverage brewing machine or the beverage. Filters can be symmetrical (e.g., fluted), or asymmetrical (e.g., pleated), element 114. Beverage material is the material used to produce a brewed beverage, such as coffee grounds, tea, or a mix beverage where the beverage material is soluble, such as hot chocolate. Beverage material may include any flavorings, nutritional content (e.g., any oils, nutritional supplements, active ingredients such as pharmaceuticals, cannabinoids, etc.), alcohol, coloring, or any other composition which has an effect on the final beverage, element 116. Beverage brewing machines for brewing portioned beverages from pre-packed beverage pods exist for a variety of beverages made from a beverage material that is either insoluble, such as coffee, or soluble, such as hot chocolate. A beverage brewing machine will typically contain many other components, such as, for example, a heating element, a liquid reservoir or plumbing component, a liquid pump, an exterior chassis, a controller for the brewing process, a display or indicator lights and sounds, a user interface including buttons or a touchscreen, a tray to catch spillage, etc. For the purposes of description, it is assumed a beverage brewing machine contains all components necessary to accomplish the beverage brewing process, though specific reference to beverage brewing machine components may only be made to those components which come into direct contact with the beverage pod, such as the brewing chamber, a fluid injecting component, and a fluid extracting component, element 118. A beverage brewing machine will contain the following elements: A beverage brewing machine will contain the following elements: A fluid source that supplies the liquid, usually water, to the brewing machine for producing the desired beverage, element 120. A brewing chamber lid that opens to allow a new pod to be added to the machine, and in many of the most common embodiments of a beverage brewing machine, the chamber lid contacts the fluid source to the brewing pin, but the fluid source does not have to be in the brewing chamber lid, element 122. A brewing pin member, or fluid injecting component, that typically has a piercing element to puncture the beverage pod lid, that provides a liquid, typically hot water, to mix with the beverage medium to create the beverage, element 124. A brewing chamber, receptacle, or sieve holder, into which the beverage pod is placed so that a beverage can be brewed, element 126. An outlet, or fluid extracting component, that typically has a piercing element to puncture the bottom of the beverage pod to allow the brewed beverage to leave the brewing chamber. Depending upon the embodiment, it may pierce or deform other components of the beverage pod, element 128. In an alternative embodiment of the present invention, the compostable gasket may be located on the lower lip of the capsule 108, shown as element 130. In such embodiments, the gasket may be fused with the lower lip using any method described as the pod bond 106. The gasket 130 may provide improved sealing through compression, and in some embodiments, may be used in isolation or in conjunction with the gasket 110.

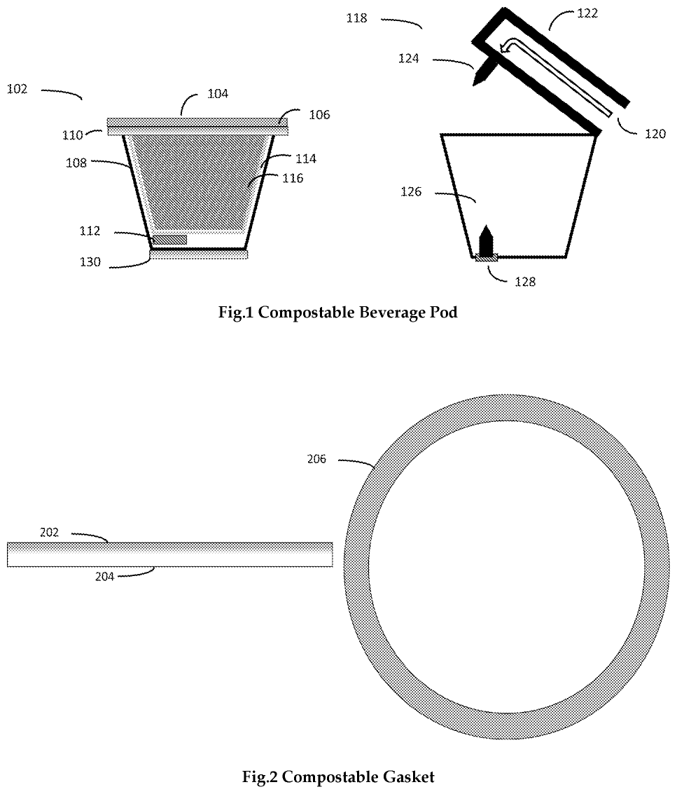

Functioning of the “Compostable Gasket” will now be explained with reference to FIG. 2. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 2 shows an exemplary embodiment of the compostable pod gasket 110. In some embodiments, the compostable pod gasket may incorporate various materials to facilitate sealing in the brewing chamber 126 and achieve material fusion with the pod capsule 108. In one embodiment, a first side of the compostable pod gasket 110 may comprise a compostable thermoplastic coating, such as PLA, PHB, or other PHAs, is shown as element 202. The thermoplastic coating may facilitate fusion with the pod capsule 108 through any means describe as the pod bond 106. In one instance, the gasket 110 may be fused with the pod capsule 108 by means of ultrasonic welding. Ultrasonic welding is a process by which high-frequency ultrasonic acoustic vibrations are locally applied to work pieces being held together under pressure to create a solid-state weld. In the present invention, the ultrasonic welding may facilitate a weld between the PLA surface of the gasket 110 and the pod exterior 108. The gasket may also be comprised, in some embodiments, of a compressible material, such as cellulosic fiber shown as element 204. The gasket 110 functions as a mechanical seal which fills the space between two or more mating surfaces, e.g., the exterior of the pod capsule 108 and the brew chamber 126, generally to prevent leakage from or into the joined objects while under compression. Cellulose fiber is a compostable, plant based material capable of providing a seal when placed under compression. The compressed cellulose thereby providing a seal that increases the potential pressure of brewing liquid into the beverage pod 102. Achieving high fluid pressure is necessary for proper brewing of certain beverages, e.g., espresso.

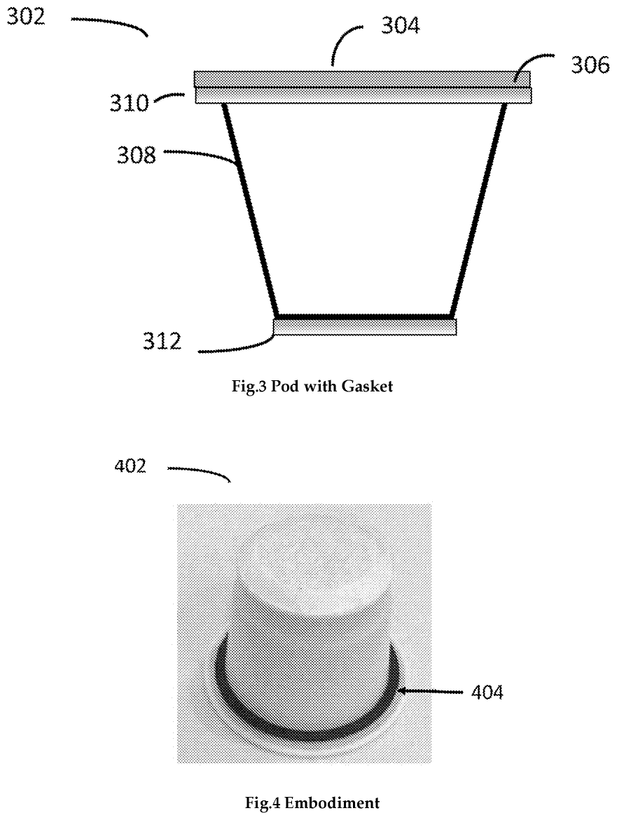

Functioning of the “Pod with Gasket” will now be explained with reference to FIG. 3. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 3 shows an exemplary pod with a compostable pod gasket. Element 302 is a compostable pod with a compostable pod gasket. The compostable pod with a compostable pod gasket 302 comprises a pod lid 304, a pod bod 306, a pod exterior 308 and a compostable pod gasket 302. Element 304 is a pod lid. Beverage cartridges can contain a number of components, including pod lid, capsule lid, or cartridge lid, is one component of a beverage pod, often made of foil, that is sealed to the pod, cartridge, capsule, etc., so as to contain the beverage medium. A compostable capsule lid may be comprised of, for example a spun bond PLA web film (which may contain a proportion of PHA, in some embodiments), a cellulose paper film, etc. In operation the pod lid 304 may be pierced by the brewing pin 124 to allow the fluid source 120 to introduce brewing liquid into the interior of the compostable pod 302. In the present invention, the brewing liquid may be ideally introduced at a specific pressure, e.g., 9 bar. The pressurization of the brewing liquid requires a tight seal between the compostable pod 302 and the brewing chamber 126. Element 306 is a pod bond. The pod bond is the connection between any two of the capsule lid, capsule outer shell, and capsule interior. This bond can be mechanical or chemical, and such as adhesives, heat sealing, ultrasonic welding, etc. The pod bond and the filter bond can be in one place or separately depending upon the use case. A filter bond is a type of capsule bond that binds the filter medium to a portion of the capsule, such as by ultrasonic welding, adhesives, thermal sealing, etc. The bod bond may also apply to other elements of the compostable pod, e.g., the compostable pod gasket 310 may also, in some embodiments, have a pod bod 306 to the pod exterior 308. Element 308 is the pod exterior, which may be, for example, a plant-based thermoplastic polymer such as PLA. In some embodiments, the pod gasket 310 may have a pod bond 306 to the pod exterior 308. In some embodiments, the pod exterior 308 may be comprised of the same or a similar thermoplastic polymer, such as PLA, used to coat at least one side of the pod gasket 310, as shown in FIG. 2 as element 202. In such embodiments, the pod bond 306 may be, for an example, an ultrasonic weld between the coated side of pod gasket 310 and pod exterior 308. Element 310 is a compostable pod gasket on the underside of the upper lip of the compostable pod with a compostable pod gasket 302. Element 312 is a compostable pod gasket on the underside of the lower lip of the compostable pod with a compostable pod gasket 302. In some embodiments, the compostable pod with compostable pod gasket may have on or more pod gaskets 310. The pod gaskets 310 may be placed, for example, at contact points with the brewing chamber 126. In some embodiments of the present invention, at least a portion of the pod gasket is comprised of a compressible material, such as cellulosic fiber. The gasket may then be compressed upon insertion into a beverage brewing device. The compressed gasket creates a seal between the pod exterior and the brewing chamber 126 of a beverage brewing device. The seal allows the beverage brewing device to provide fluid to the compostable pod with compostable pod gasket 302 at an increased pressure. In some embodiments, the increased fluid pressure may provide improved extraction for certain brewed beverage, which may be, for example, espresso or espresso-like beverages. For espresso and espresso-like beverages, fluid pressure up to approximately 9 bars may be required for ideal beverage properties.

Functioning of the “Embodiment” will now be explained with reference to FIG. 4. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 4 shows an exemplary embodiment of the Compostable pod with Gasket ring. The compostable pod is shown as element 402, with a compostable pod lid 104 at the top of the image and the gasket ring fused to the underside of the capsule lip shown as element 404. In operation, the Compostable pod 402 may be inserted into the brew chamber 126 of a beverage brewing machine 118. A brew chamber lid 122 may close down upon the brew chamber 126, enclosing the beverage pod 402 inside the brew chamber 126. In some embodiments, the brew chamber lid 122 may cause the gasket ring 404 to become compressed, creating a tight seal about the beverage pod 402 between the inlet 120 and the brewing pin 128. The tight seal increases the fluid pressure from the inlet 120, thus causing improved extraction of the beverage material 116. In some embodiments, the beverage material may be, for example, espresso coffee grounds. It is well known that espresso extraction occurs optimally at high pressure, typically around 9 bar (e.g., 9 times the atmospheric pressure at sea level). In some embodiments, the thickness of the compostable gasket 404 may be selected based, at least in part, on the desired pressure of the beverage material 116 extraction. In other embodiments, the thickness of the compostable gasket 404 may be based, at least in part, on the parameters (e.g., size and dimensions) of the brew chamber 126. In some embodiments, the compostable gasket 404 may be removable to accommodate brew chambers 126 with less tolerance for gasket compression.

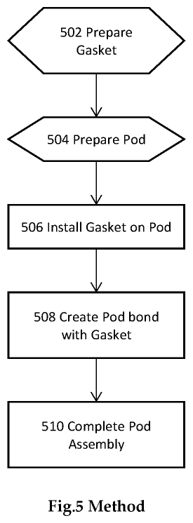

Functioning of the “Method” will now be explained with reference to FIG. 5. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 5 shows a method of manufacturing a compostable beverage pod with a compostable gasket. Step 1 is 502 Prepare Gasket; in this step the final gasket is prepared for installation. This may include for example, coating one side of a Cellulose fiber sheet with PLA, and then cutting the gasket shape out of the coated sheet. In some embodiments, a coated cellulose fiber sheet may be provided from a 3rd party supplier. The step may include loading the sheet onto a cutting machine and cutting at least one gasket out of the sheet. Finally, the step may involve loading the prepared gaskets into an installation machine. In one embodiment, the gaskets may be loaded in a single or multiple stacks, allowing the coated side of each gasket to remain in the correct orientation relative to the pod. In such embodiments, the correct orientation relative to the pod may be, for example, any orientation such that the coated side of the gasket is capable of mating with the exterior of the capsule. Step 2 is 504 Prepare Pod; in this step the pod is prepared to receive the gasket. The may include, for example, any steps needed to create the pods final shape to receive the gasket, loading the pods into a gasket installation device, etc. In some embodiments, the pods may be loaded in a single or multiple stacks, allowing the pods to maintain correct orientation relative to the gasket installation device. Step 3 is 506 Install Gasket on Pod, a step where the gasket is placed on the pod in the vicinity of where the gasket will be bonded to the pod. In some embodiments, the gasket may be placed above or below one or more portions of the exterior of the pod, such as, for example, below the upper lip of the pod where the exterior of the pod contacts the brew basket 126 during a beverage brewing process. Step 4 is 508 Create Pod bond with Gasket, a step where the gasket is bonded with the pod exterior. The gasket may be bonded in any method suitable for a compostable or non-compostable beverage pod, such as, for example, adhesive or ultrasonic welding. In some embodiments, the pod bond may be a friction fit, compression fit, screw threading, clip-in, seating the gasket in a groove (typical with O-ring gaskets) or another mechanical means of affixing the gasket without the need for additional energetic or chemical bonding. Step 5 is 510 Complete Pod Assembly, a step where any remaining processes of beverage pod assembly is completed before a final pod is produced. The step may include, for example, inserting a filter element 114, dosing the pod with beverage material 116, inserting a registration element 112, applying lidding material 110 and applying a pod bond 106, etc. It should be obvious to one skilled in the art that the aforementioned steps can be completed in any order, or completed partially before one step and completed after another step, or any such arrangement of steps in order to produce an assembled beverage pod.

1. (canceled)

2. A beverage container for holding beverage ingredients, comprising:
a beverage pod including
a main body defining a chamber holding the beverage ingredients,
a lip extending outwardly from the main body, wherein the lip includes an upper surface and a lower surface, and
a lid extending across the chamber and the upper surface of the lip; and
a gasket bonded to the lower surface of the lip such that the lip extends outwardly past the gasket, wherein the gasket is configured to be compressed by a brewing device to form a seal between the brewing device and the beverage container to maintain a pressure differential between the chamber of the beverage pod and an external environment.

3. The beverage container of claim 2, wherein the beverage ingredients include espresso coffee grounds, and a bond between the gasket and the lip is configured to remain intact when the brewing device pressurizes the chamber to fluid pressures up to 9 bars to brew an espresso beverage.

4. The beverage container of claim 2, wherein the gasket is a planar ring comprising a compressible material.

5. The beverage container of claim 2, wherein the gasket includes a plurality of layers comprising a compostable compressible material.

6. The beverage container of claim 2, wherein the gasket comprises cellulosic fibers.

7. The beverage container of claim 2, further comprising a filter medium coupled to the lip between the lid and the gasket, wherein the beverage ingredients are held between the filter medium and the lid.

8. A method of brewing an espresso beverage, the method comprising:
placing a beverage container in a brewing device, the beverage container including
a beverage pod including
a main body defining a chamber holding beverage ingredients,
a lip extending outwardly from the main body, wherein the lip includes an upper surface and a lower surface, and
a lid extending across the chamber and the upper surface of the lip, and
a gasket coupled to the lower surface of the lip;
forming a seal between the brewing device and the gasket; and
while a brewing pin of the brewing device extends through the lid, delivering brewing liquid at fluid pressures up to 9 bars from the brewing pin while the seal between the brewing device and the gasket is maintained such the brewing liquid flows through the beverage container to brew the espresso beverage.

9. The method of claim 8, wherein the brewing device sealing engages the beverage container and includes a pump configured to pressurize the brewing liquid in the chamber to 9 bars.

10. The method of claim 8, further comprising maintaining the seal while a fluid pressure of the brewing liquid in the chamber is higher than atmospheric pressure.

11. The method of claim 8, wherein the lip extends outwardly past the gasket.
